(19) United States
(12) Patent Application Publication
(10) Pub. No.: US 2013/0210363 A1
(43) Pub. Date: Aug. 15, 2013

(54) RECEIVER DEVICE, HOST APPARATUS AND CONTROL METHOD THEREOF

(71) Applicant: THLIGHT CO. LTD., (US)

(72) Inventors: CHENG-JAN CHI, New Taipei City (TW); CHENG-YUAN SHIH, Taipei City (TW); JUN-WEI YEH, New Taipei City (TW); PO-CHUN HU, Taipei City (TW); JUI-CHI YEN, Taipei City (TW); CHIN-NAN HUANG, New Taipei City (TW); HUNG-TING LI, Taipei City (TW)

(73) Assignee: THLIGHT CO. LTD., Taipei City (TW)

(21) Appl. No.: 13/762,597

(22) Filed: Feb. 8, 2013

(30) Foreign Application Priority Data
Feb. 14, 2012 (TW) 101104765

(51) Int. Cl. H04W 4/00

(52) U.S. Cl. CPC H04W 4/008
USPC 455/41.3; 455/552.1

(57) ABSTRACT

A receiver device adapted to be plugged in a host apparatus is provided. The receiver device includes a Bluetooth receiver unit, a processing unit and a transmission module. The Bluetooth receiver unit, signal connected to a smart handheld device via a Bluetooth transmission interface, is configured to receive a control signal issued from the smart handheld device. The processing unit, electrically connected to the Bluetooth receiver unit, is configured to convert the control signal into a control instruction. The transmission module, electrically connected to the processing unit and linked to the host apparatus via a transmission port of the host apparatus, is configured to transmit the control instruction to the host apparatus via the transmission port, wherein the host apparatus is controlled by the control instruction to perform a specified operation. A host apparatus and associated control method are also provided.

### FIELD OF THE INVENTION

The present invention relates to the Bluetooth technical field, and more particularly to a receiver device, a host apparatus and a control method thereof associated with the Bluetooth technical field.

### BACKGROUND OF THE INVENTION

With the advancement of technology, smart phones gradually replace the traditional mobile phones. Today, smart phones have been able to combine multimedia, e-mail and Internet access. In addition, users even can operate a host device, such as a personal computer, via the smart phone.

In the conventional technology, to control a host apparatus via a smart phone, the user must sent control instructions to the Wireless Fidelity (Wi-Fi) base station and thereby transmitting the control instructions to the host apparatus via the Internet. Because the control instructions must be transmitted to the host apparatus via the Wi-Fi base station, not only the transmission speed is limited by the Wi-Fi base station but also requiring much effort to simultaneously configure the Wi-Fi settings on the smart phone and the host apparatus both.

### SUMMARY OF THE INVENTION

The present invention provides a receiver device, a host apparatus and a control method thereof. Through the receiver device, the host apparatus is capable of being control by a smart handheld device without a Wi-Fi connection.

The present invention provides a receiver device adapted to be plugged in a host apparatus. The receiver device includes a Bluetooth receiver unit, a processing unit and a transmission module. The Bluetooth receiver unit, signal connected to a smart handheld device via a Bluetooth transmission interface, is configured to receive a control signal issued from the smart handheld device. The processing unit, electrically connected to the Bluetooth receiver unit, is configured to convert the control signal into a control instruction. The transmission module, electrically connected to the processing unit and linked to the host apparatus via a transmission port of the host apparatus, is configured to transmit the control instruction to the host apparatus via the transmission port, wherein the host apparatus is controlled by the control instruction to perform a specified operation.

The present invention further provides a control method for an operation of a host apparatus. The control method includes steps of: establishing a control connection between a smart handheld device and the host apparatus via a Bluetooth transmission interface; displaying an operation interface on a screen of the smart handheld device; generating a control signal response to an operation of a user on the operation interface; and transmitting the control signal to the host apparatus via the control connection and thereby controlling an operation of the host apparatus.

The present invention still provides a control method for controlling a host apparatus. The control method includes steps of: converting a control signal into a control instruction after receiving the control signal from a smart handheld device via a Bluetooth transmission interface; and transmitting the control instruction to the host apparatus via a transmission port thereof and thereby controlling an operation of the host apparatus.

The present invention yet provides a control method for an operation of a host apparatus. The control method includes steps of: establishing a control connection between the host apparatus and a control application software installed a smart handheld device via a Bluetooth transmission interface; establishing, by an operation system of the host apparatus, a corresponding device description bit according to a control signal generated by the control application software and thereby recognizing, by the operation system, the smart handheld device as a peripheral device; and converting the control signal into a control instruction, for controlling the host apparatus, according to the device description bit established in the operation system.

The present invention still yet provides a host apparatus, which includes a control module and a receiver module. The control module is configured to control an operation of the host apparatus. The receiver module is electrically connected to the control module and includes a Bluetooth receiver unit, a processing unit and a transmission module. The Bluetooth receiver unit, signal connected to a smart handheld device via a Bluetooth transmission interface, is configured to receive a control signal issued from the smart handheld device. The processing unit, electrically connected to the Bluetooth receiver unit, is configured to convert the control signal into a control instruction. The transmission module, electrically connected to the processing unit and the control module, is configured to transmit the control instruction to the control module for being processed by an operation system of the host apparatus.

In summary, through employing the Bluetooth transmission interface to transmit the control signal issued from the smart handheld device, the present invention can control the host apparatus without via the Wi-Fi network.

### BRIEF DESCRIPTION OF THE DRAWINGS

The present invention will become more readily apparent to those ordinarily skilled in the art after reviewing the following detailed description and accompanying drawings, in which:

FIG. 1A is a schematic view illustrating a receiver device and a host apparatus in accordance with an embodiment of the present invention corporately used with a smart handheld apparatus;

FIG. 1B is a schematic block view of the receiver device shown in FIG. 1A;

FIG. 2 is a flowchart illustrating a control method for the smart handheld apparatus to control an operation of the host apparatus shown in FIG. 1A in accordance with an embodiment of the present invention;

FIGS. 3A and 3B are alternative flowcharts illustrating a control method for the smart handheld apparatus to control an operation of the host apparatus shown in FIG. 1A in accordance with an embodiment of the present invention; and

FIG. 4 is a schematic view illustrating a process of a smart handheld device controlling a host apparatus in accordance with an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

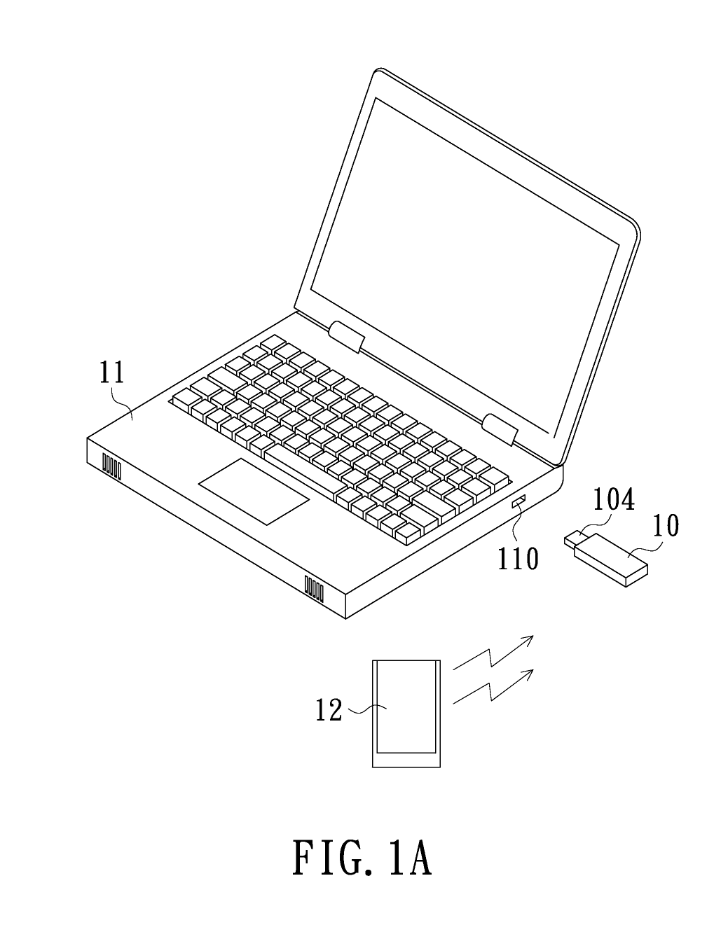

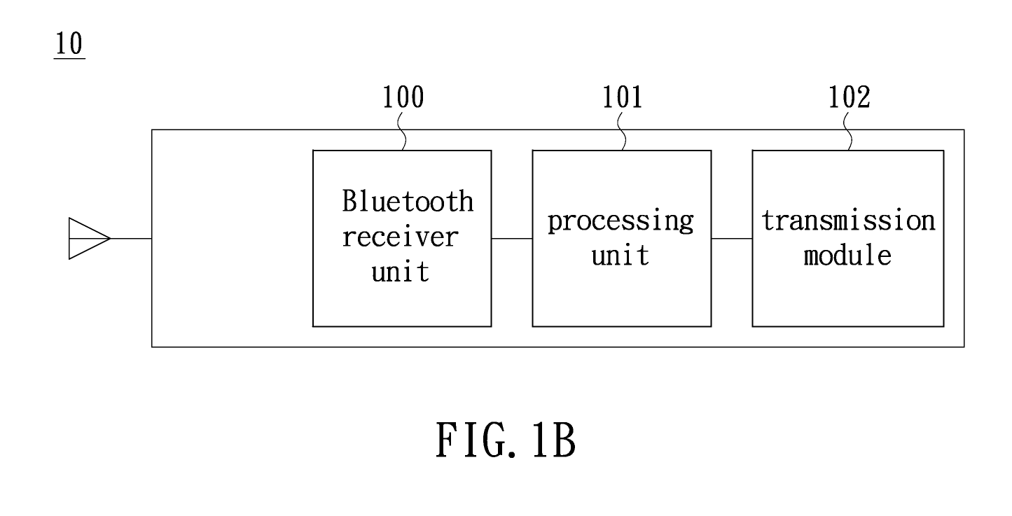

FIG. 1A is a schematic view illustrating a receiver device and a host apparatus in accordance with an embodiment of the present invention corporately used with a smart handheld apparatus; and FIG. 1B is a schematic block view of the receiver device shown in FIG. 1A. As shown, the receiver device 10 is capable of being plugged in the host apparatus 11 via a transmission port 110 thereof and thereby being linked to the host apparatus 11. In this embodiment, the transmission port 110 is, for example, a Universal Series Bus (USB) port; and the host apparatus 11 is, for example, a personal computer, a notebook computer or a TV set-top box.

The receiver device 10 is configured to receive a control signal transmitted from the smart handheld apparatus 12 via a Bluetooth transmission interface and thereby controlling the host apparatus 11 according to the control signal. In one embodiment, the smart handheld apparatus 12 is a smart phone or a pocket mobile device.

As shown in FIG. 1B, the receiver device 10 includes a Bluetooth receiver unit 100, a processing unit 101 and a transmission module 102; wherein the processing unit 101 is electrically connected between the Bluetooth receiver unit 100 and the transmission module 102. The transmission module 102 includes a transmission connector 104 (shown in FIG. 1A); wherein the transmission connector 104 in this embodiment is an USB 2.0 or 3.0 connector, through which the receiver device 10 can be plugged in the transmission port 110 of the host apparatus 11.

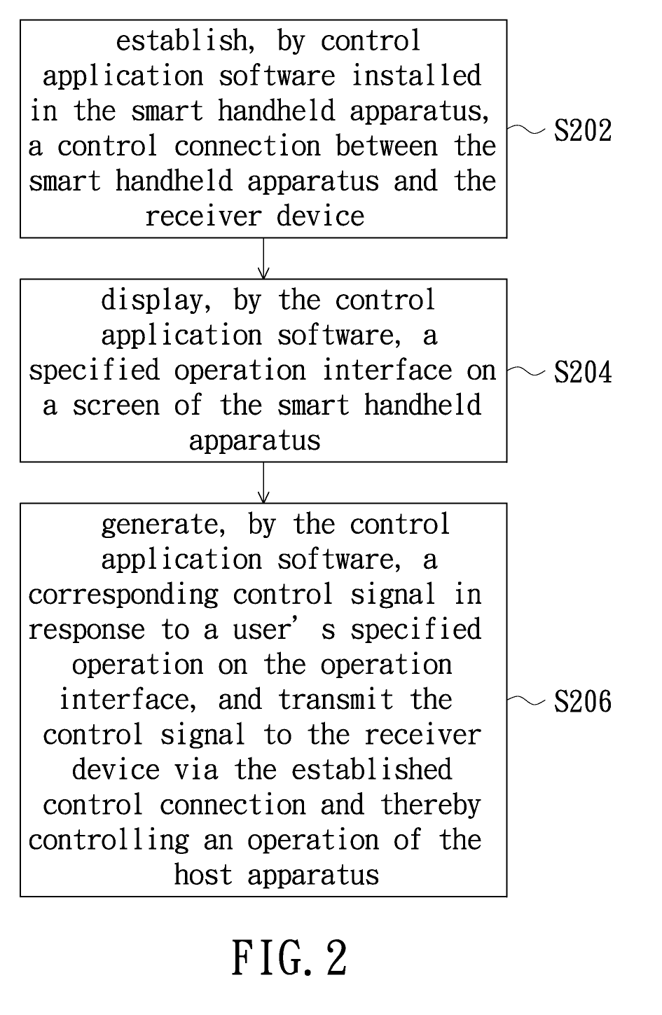

FIG. 2 is a flowchart illustrating a control method for the smart handheld apparatus 12 to control an operation of the host apparatus 11 shown in FIG. 1A in accordance with an embodiment of the present invention. Please refer to FIGS. 1A, 2. In this embodiment, the smart handheld apparatus 12 is installed with control application software, which is configured to establish a control connection between the smart handheld apparatus 12 and the receiver device 10 via the Bluetooth transmission interface (step S202). The means for the Bluetooth control connection establishment between the smart handheld apparatus 12 and the receiver device 10 is a well-known technology, and no unnecessary detail is given here. Then, the control application software is further configured to display a specified operation interface on a screen of the smart handheld apparatus 12 (step S204). Then, the control application software is further configured to generate a corresponding control signal in response to a user's specified operation on the operation interface, and transmit the control signal to the receiver device 10 via the aforementioned established control connection, and thereby controlling an operation of the host apparatus 11 (step S206). The features of the operation interface will be described in detail in follows.

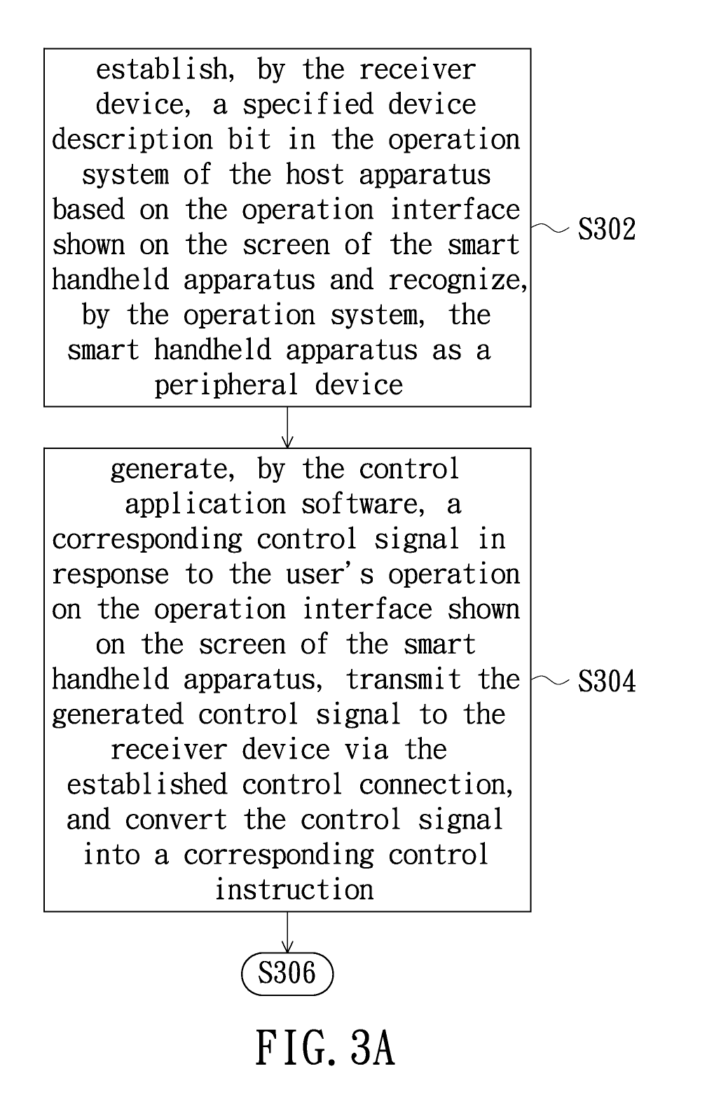

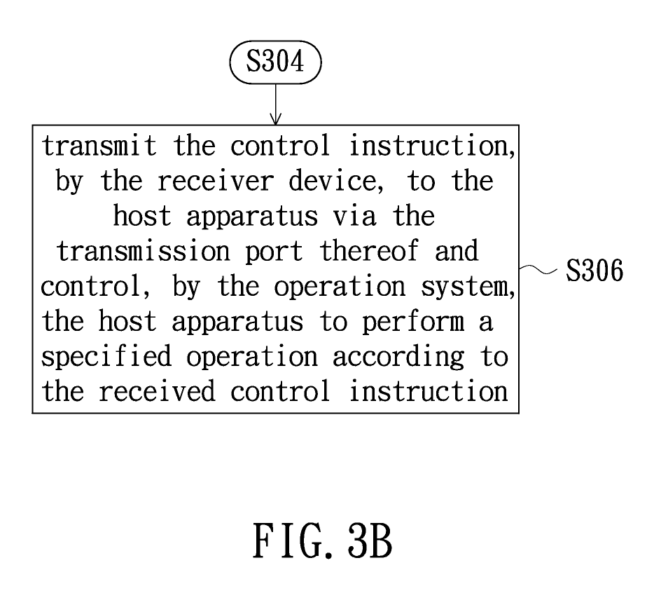

FIGS. 3A and 3B are alternative flowcharts illustrating a control method for the smart handheld apparatus 12 to control an operation of the host apparatus 11 shown in FIG. 1A in accordance with another embodiment of the present invention. Please refer to FIGS. 1A, 3A and 3B. The receiver device 10 is further configured to, after the verification between the receiver device 10 and the smart handheld apparatus 12 is complete and the control connection therebetween is established via the Bluetooth transmission interface, establish a specified device description bit in the operation system of the host apparatus 11 based on the operation interface shown on the screen of the smart handheld apparatus 12, and consequentially the operation system of the host apparatus 11 can recognize the smart handheld apparatus 12 as a corresponding peripheral device according to this specified device description bit (step S302).

For example, in one embodiment, the control application software first issues a corresponding control signal to the receiver device 10 if being configured to provide a cursor operation interface on the screen of the smart handheld apparatus 12; then, the receiver device 10 establishes a corresponding device description bit in the operation system of the host apparatus 11 according to the received control signal; and consequently the host apparatus 10 can recognize this smart handheld apparatus 12 as a mouse device. It is understood that the smart handheld apparatus 12 is not limited to function as a mouse device. In other words, the control application software can be configured to display various operation interfaces (such as a virtual keyboard, a multimedia or a presentation operation interfaces) on the screen of the smart handheld apparatus 12 based on the user's requirements; accordingly, the host apparatus 11 can recognize the smart handheld apparatus 12 as a specified peripheral device (such as a keyboard or a mouse) according to the respective device description bit established in the operation system thereof.

Then, the control application software is further configured to generate a corresponding control signal in response to the user's operation on the operation interface shown on the screen of the smart handheld apparatus 12. The generated control signal first is transmitted from the smart handheld apparatus 12 to the receiver device 10 via the established control connection therebetween and then converted into a corresponding control instruction by the receiver device 10 (step S304). Afterwards, the control instruction is transmitted to the host apparatus 11 via the transmission port 110 thereof; and thus, the operation system of the host apparatus 11 can control the host apparatus 11 to perform a specified operation according to the received control instruction (step S306).

Specifically, the control application software first issues a corresponding cursor control signal to the receiver device 10 in response to that the user is moving his/her finger on the cursor operation interface shown on the screen of the smart handheld apparatus 12; then, the processing unit 101 of the receiver device 10, after receiving the cursor control signal via the Bluetooth receiver unit 100, converts the received cursor control signal into a corresponding cursor control instruction and transmits the cursor control instruction to the transmission module 102; afterwards, the transmission module 102 transmits the cursor control instruction to the host apparatus 11 via the transmission port 110 thereof. Thus, the operation system of the host apparatus 11 can move the cursor on the screen thereof according to the cursor control instruction; in other words, the user can control the movement of the cursor on the screen of the host apparatus 11 by moving his/her finger on the screen of the smart handheld apparatus 12.

In another embodiment, likewise, if being configured to provide a virtual keyboard interface on the screen of the smart handheld apparatus 12, the control application software first issues a corresponding byte input signal to the receiver device 10 in response to that a user is pressing a virtual button on the virtual keyboard interface; then, the processing unit 101 of the receiver device 10, after receiving the byte input signal via the Bluetooth receiver unit 100, converts the received byte input signal into a corresponding keyboard control instruction and transmits the keyboard control instruction to the transmission module 102; afterwards, the transmission module 102 transmits the keyboard control instruction to the host apparatus 11 via the transmission port 110 thereof. Thus, through the virtual keyboard interface shown on the screen of the smart handheld apparatus 12, the user can input byte to the host apparatus 11.

In still another embodiment, likewise, if being configured to provide a multimedia operation interface on the screen of the smart handheld apparatus 12, the control application software first issues a corresponding multimedia control signal to the receiver device 10 in response to that a user is selecting a specified function such as “Play”, “Next”, “Previous”, “Forward” or “Backward” on the multimedia operation interface; then, the processing unit 101 of the receiver device 10, after receiving the multimedia control signal via the Bluetooth receiver unit 100, converts the received multimedia control signal into a corresponding multimedia control instruction and transmits the multimedia control instruction to the transmission module 102; afterwards, the transmission module 102 transmits the multimedia control instruction to the host apparatus 11 via the transmission port 110 thereof. Thus, through the multimedia operation interface shown on the screen of the smart handheld apparatus 12, the user can execute a particular multimedia program in the host apparatus 11.

In yet another embodiment, likewise, if beings configured to provide a presentation operation interface on the display screen of the smart handheld apparatus 12, the control application software first issues a corresponding presentation control signal to the receiver device 10 in response to that a user is selecting a specified operation such as “Page-Up” or “Page-Down” on the presentation operation interface; then, the processing unit 101 of the receiver device 10, after receiving the presentation control signal via the Bluetooth receiver unit 100, converts the received presentation control signal into a corresponding mouse or keyboard control instruction and transmits the mouse or keyboard control instruction to the transmission module 102; afterwards, the transmission module 102 transmits the mouse or keyboard control instruction to the host apparatus 11 via the transmission port 110 thereof. Thus, through the presentation operation interface shown on the screen of the smart handheld apparatus 12, the user can control the host apparatus 11 to perform a corresponding presentation operation.

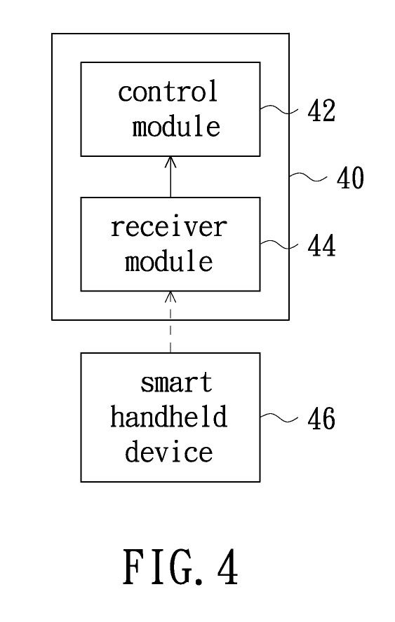

FIG. 4 is a schematic view illustrating a process of a smart handheld device controlling a host apparatus in accordance with an embodiment of the present invention. In this embodiment, as shown, the receiver device 10 in the previous embodiment is integrated into the host apparatus 40, which includes a control module 42 and a receiver module 44. The control module 42, configured to control the operations of the host apparatus 40, includes a processor and other related components (not shown). The receiver module 44 is coupled to the control module 42 and has an internal circuit same as that in the receiver device 10 and is capable of being signal connected to a smart handheld device 46.

Likewise, the smart handheld device 46 is installed with control application software, which is configured to establish a control connection with the receiver module 44 and display an operation interface on the screen of the smart handheld device 46. In addition, the control application software is further configured to generate a control signal in accordance with the user's specified operation on the operation interface. The receiver module 44 is configured to, after receiving the control signal via the established control connection, convert the control signal into a control instruction and transmit the control instruction to the control module 42. Thus, the user can control the operation of the host apparatus 40 through the smart handheld device 46.

In summary, through employing the Bluetooth transmission interface to transmit the control signal issued from the smart handheld device, the present invention can control the host apparatus without via the Wi-Fi network.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A receiver device adapted to be plugged in a host apparatus, the receiver device comprising:
a Bluetooth receiver unit, signal connected to a smart handheld device via a Bluetooth transmission interface, configured to receive a control signal issued from the smart handheld device;
a processing unit, electrically connected to the Bluetooth receiver unit, configured to convert the control signal into a control instruction; and
a transmission module, electrically connected to the processing unit and linked to the host apparatus via a transmission port of the host apparatus, configured to transmit the control instruction to the host apparatus via the transmission port, wherein the host apparatus is controlled by the control instruction to perform a specified operation.

2. The receiver device according to claim 1, wherein the transmission module comprises a transmission connector capable of being plugged in the transmission port.

3. The receiver device according to claim 2, wherein the transmission connector is an USB 2.0 connector.

4. The receiver device according to claim 2, wherein the transmission connector is an USB 3.0 connector.

5. A control method for an operation of a host apparatus, comprising steps of:
establishing a control connection between a smart handheld device and the host apparatus via a Bluetooth transmission interface;
displaying an operation interface on a screen of the smart handheld device;
generating a control signal response to an operation of a user on the operation interface; and
transmitting the control signal to the host apparatus via the control connection and thereby controlling an operation of the host apparatus.

6. The control method according to claim 5, wherein the operation interface is a cursor operation interface.

7. The control method according to claim 5, wherein the operation interface is a virtual keyboard interface.

8. The control method according to claim 5, wherein the operation interface is a multimedia operation interface.

9. The control method according to claim 5, wherein the operation interface is a presentation operation interface.

10. A control method for controlling a host apparatus, comprising steps of:
converting a control signal into a control instruction after receiving the control signal from a smart handheld device via a Bluetooth transmission interface; and
transmitting the control instruction to the host apparatus via a transmission port thereof and thereby controlling an operation of the host apparatus.

11. The control method according to claim 10, wherein the control instruction is a mouse control instruction, for controlling a movement of a cursor on a screen of the host apparatus, if the control signal is a cursor control signal.

12. The control method according to claim 10, wherein the control instruction is a keyboard control instruction, for inputting bytes into the host apparatus, if the control signal is a byte input signal.

13. The control method according to claim 10, wherein the control instruction is a keyboard control instruction, for controlling an operation of a multimedia play application software installed in the host apparatus, if the control signal is a multimedia control signal.

14. The control method according to claim 10, wherein the control instruction is a mouse control instruction or a keyboard control instruction, for controlling an operation of a presentation application software installed in the host apparatus, if the control signal is a presentation control signal.

15. A control method for an operation of a host apparatus, comprising steps of:
establishing a control connection between the host apparatus and a control application software installed a smart handheld device via a Bluetooth transmission interface;
establishing, by an operation system of the host apparatus, a corresponding device description bit according to a control signal generated by the control application software and thereby recognizing, by the operation system, the smart handheld device as a peripheral device; and
converting the control signal into a control instruction, for controlling the host apparatus, according to the device description bit established in the operation system.

16. The control method according to claim 15, wherein the peripheral device is a mouse.

17. The control method according to claim 15, wherein the peripheral device is a keyboard.

18. A host apparatus, comprising:
a control module configured to control an operation of the host apparatus; and
a receiver module electrically connected to the control module and comprising:
a Bluetooth receiver unit, signal connected to a smart handheld device via a Bluetooth transmission interface, configured to receive a control signal issued from the smart handheld device;
a processing unit, electrically connected to the Bluetooth receiver unit, configured to convert the control signal into a control instruction; and
a transmission module, electrically connected to the processing unit and the control module, configured to transmit the control instruction to the control module for being processed by an operation system of the host apparatus.

19. The host apparatus according to claim 18, wherein the control module comprises a processor.
